(19) United States
(12) Patent Application Publication
(10) Pub. No.: US 2020/0087508 A1
(43) Pub. Date: Mar. 19, 2020

(54) CATALYST-FREE CURABLE EPOXY COMPOSITIONS

(71) Applicant: SABIC GLOBAL TECHNOLOGIES B.V., Bergen Op Zoom (NL)

(72) Inventors: Mukesh AGRAWAL, Bangalore (IN); NIKHIL K.E. VERGHESE, Maastricht (NL)

(21) Appl. No.: 16/543,005

(22) Filed: Aug. 16, 2019

(30) Foreign Application Priority Data
Sep. 13, 2018 (EP) 18194248.3

(51) Int. Cl. C08L 63/04; C08G 59/42; C08L 63/06; C08G 59/24; C08G 59/32

(52) U.S. Cl. CPC C08L 63/04; C08G 59/4223; C08G 59/32; C08G 59/245; C08L 63/06

(57) ABSTRACT

A curable epoxy composition, comprising: 100 parts by weight of an epoxy resin composition comprising one or more epoxy resins, each independently having an epoxy equivalent weight of at least 2; 30 to 200 parts by weight of an aromatic dianhydride curing agent of formula (1)

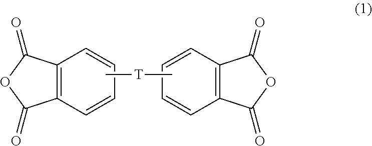

wherein T is —O—, —S—, —C(O)—, —SO₂—, —SO—, —C_{y}H_{2y}— wherein y is an integer from 1 to 5 or a halogenated derivative thereof, or —O—Z—O— wherein Z is an aromatic C₆₋₂₄ monocyclic or polycyclic moiety optionally substituted with 1 to 6 C₁₋₈ alkyl groups, 1 to 8 halogen atoms, or a combination comprising at least one of the foregoing, wherein the composition does not contain a catalyst.

### BACKGROUND

Thermoset polymers are used in a wide variety of consumer and industrial products including protective coatings, adhesives, electronic laminates (such as those used in the fabrication of printed circuit boards), flooring and paving, glass fiber-reinforced pipes, and automotive parts (such as leaf springs, pumps, and electrical components). Thermoset epoxies are commonly derived from thermosetting epoxy resins that are polymerized in the presence of a co-reactive curing agent (also referred to in the art as a hardener) and a catalytic curing agent (also referred to in the art as a cure accelerator or a catalyst) to afford a cured thermoset polymer.

Anhydride curing agents can be used to provide cured epoxies having higher heat properties, better electrical properties, longer pot life, and lower shrinkage. Aromatic dianhydrides are a class of anhydride curing agents that can provide high density crosslinking to the cured thermoset epoxy, which can further enhance the high heat properties. However, curing epoxy formulations that include dianhydrides often requires the use of a curing catalyst in conjunction with high temperatures (e.g., 200° C.) for extended periods of time (e.g., 24 hours). The use of curing catalysts can deteriorate the properties of the resulting cured epoxy product, and increase both the complexity and cost of the curing process.

Accordingly, there remains a need for curable epoxy compositions suitable for manufacturing thermoset (cured) epoxy resins for high heat applications. More particularly, there remains a need for curable epoxy compositions that can be cured in the absence of a curing catalyst.

### BRIEF DESCRIPTION

According to an aspect, a curable epoxy composition comprises 100 parts by weight of an epoxy resin composition comprising one or more epoxy resins, each independently having an epoxy equivalent weight of at least 2; 30 to 200 parts by weight of an aromatic dianhydride curing agent of formula (1)

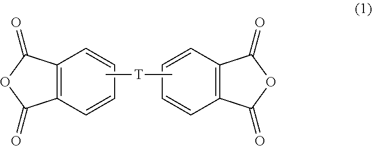

wherein T is —O—, —S—, —C(O)—, —SO₂—, —SO—, —C_{y}H_{2y}— wherein y is an integer from 1 to 5 or a halogenated derivative thereof, or —O—Z—O— wherein Z is an aromatic C₆₋₂₄ monocyclic or polycyclic moiety optionally substituted with 1 to 6 C₁₋₈ alkyl groups, 1 to 8 halogen atoms, or a combination comprising at least one of the foregoing, wherein the composition does not contain a catalyst.

According to another aspect, a method for the manufacture of the curable epoxy composition comprises contacting the epoxy resin composition and the aromatic dianhydride curing agent at a temperature of 130 to 200° C., preferably 140 to 190° C., more preferably 150 to 180° C. to provide the curable epoxy composition.

In an aspect, a thermoset epoxy composition comprising a cured product of the curable epoxy composition is provided.

According to still another aspect, a method for the manufacture of a thermoset epoxy composition comprises curing the curable epoxy composition, wherein the curing is performed without a catalyst; preferably wherein the curing of the curable epoxy composition comprises compression molding, injection molding, transfer molding, pultrusion, resin casting, or a combination comprising at least one of the foregoing.

In an aspect, an article comprising the thermoset epoxy composition is provided.

The above described and other features are exemplified by the following detailed description.

### DETAILED DESCRIPTION

This disclosure relates to a catalyst-free curable epoxy composition including an epoxy resin and an aromatic dianhydride as curing agent. The inventors have discovered that an aromatic dianhydride, for example bisphenol-A dianhydride (BPA-DA), can be a useful curing agent for making high heat cured epoxies in the absence of a catalyst. The curable epoxy composition including the aromatic dianhydride as an epoxy curing agent can provide a cured thermoset product having good high heat resistance properties, such as a glass transition temperature that can be greater than 210° C. Moreover, the curing time and heat of polymerization when using the curable epoxy composition may be less than those of other curable epoxy compositions that do not include the aromatic dianhydride curing agent. The disclosed curable epoxy composition and the corresponding cured thermoset product can be used in a variety of high heat applications including but not limited to adhesives, coatings, epoxy tooling compositions, potting compositions, and fiber-reinforced composites.

The curable epoxy composition includes 100 parts by weight of an epoxy resin composition comprising one or more epoxy resins, each independently having an epoxy equivalent weight of at least 2; and 30 to 200 parts by weight of an aromatic dianhydride curing agent. The curable epoxy composition does not contain a catalyst or accelerator.

In particular embodiments, the stoichiometric ratio between the aromatic dianhydride curing agent and the epoxy resin composition is 0.1:1 to 2.0:1, preferably 0.4:1 to 1.2:1, more preferably 0.6:1 to 1:1. The stoichiometric ratio is the molar ratio of anhydride functionalities in the dianhydride curing agent to the epoxy functionalities in the epoxy resin composition. The stoichiometric ratio is also referred to herein as the anhydride to epoxy (A/E) ratio.

In some embodiments, the curable epoxy composition includes 50 to 150, preferably 60 to 140, more preferably 80 to 120 parts by weight of the aromatic dianhydride curing agent, based on the total parts by weight of the epoxy resin composition and the aromatic dianhydride curing agent.

The epoxy resin composition can be a bisphenol A epoxy resin, a triglycidyl-substituted epoxy resin, a tetraglycidyl-substituted epoxy resin, a bisphenol F epoxy resin, a phenol novolak epoxy resin, a cresol novolak epoxy resin, a cycloaliphatic diglycidyl ester epoxy resin, a cycloaliphatic epoxy resin comprising a ring epoxy group, an epoxy resin containing a spiro-ring, a hydantoin epoxy resin, or a combination comprising at least one of the foregoing. In an embodiment, the epoxy resin is bisphenol-A diglycidyl ether (BPA-DGE).

The aromatic dianhydride can be of the formula (1)

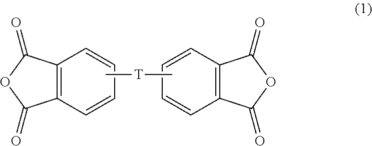

wherein T is —O—, —S—, —C(O)—, —SO₂—, —SO—, —C_{y}H_{2y}— wherein y is an integer from 1 to 5 or a halogenated derivative thereof, or —O—Z—O— wherein Z is an aromatic C₆₋₂₄ monocyclic or polycyclic moiety optionally substituted with 1 to 6 C₁₋₈ alkyl groups, 1 to 8 halogen atoms, or a combination comprising at least one of the foregoing. In some embodiments, the R¹ is a monovalent C₁₋₁₃ organic group. In some embodiments, T is —O— or a group of the formula —O—Z—O— wherein the divalent bonds of the —O— or the —O—Z—O— group are in the 3,3′, 3,4′, 4,3′, or the 4,4′ positions.

Exemplary groups Z include groups of formula (2)

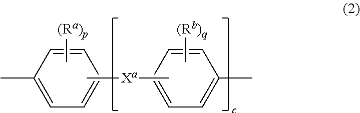

wherein R^{a} and R^{b} are each independently the same or different, and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (3a) or (3b)

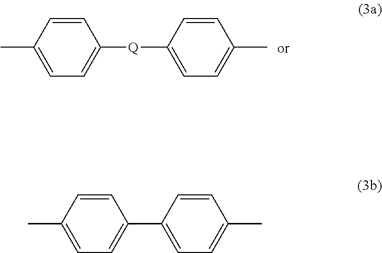

wherein Q is —O—, —S—, —C(O)—, —SO₂—, —SO—, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (including a perfluoroalkylene group). In some embodiments, Q is 2,2-isopropylidene.

In some embodiments, T is —O—Z—O—, preferably wherein Z is derived from bisphenol A (i.e., Z is 2,2-(4-phenylene)isopropylidene). Illustrative examples of aromatic dianhydrides include 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride; and, 4-(2,3-dicarboxyphenoxy)-4′-(3,4-dicarboxyphenoxy)diphenyl sulfone dianhydride.

In some embodiments, the curable epoxy composition includes an additive composition. The additive composition can include a particulate filler, a fibrous filler, a reinforcing material, an antioxidant, a heat stabilizer, a light stabilizer, a ultraviolet light stabilizer, a ultraviolet light-absorbing compound, a near infrared light-absorbing compound, an infrared light-absorbing compound, a plasticizer, a lubricant, a release agent, a antistatic agent, an anti-fog agent, an antimicrobial agent, a colorant, a surface effect additive, a radiation stabilizer, a flame retardant, flame retardant synergists such as antimony pentoxide, an anti-drip agent, a fragrance, an adhesion promoter, a flow enhancer, a coating additive, a polymer different from the thermoset polymer, or a combination comprising at least one of the foregoing. In a preferred embodiment, the additive composition comprises a flame retardant, a particulate filler, a fibrous filler, an adhesion promoter, a flow enhancer, a coating additive, a colorant, or a combination comprising at least one of the foregoing.

In particular embodiments, the additive composition includes a particulate filler. The particulate filler can include alumina powder, hydrated alumina powder, quartz powder or fused quartz powder, glass fibers, carbon fibers, or a combination comprising at least one of the foregoing. In one embodiment, the curable composition further comprises a fibrous substrate (woven or non-woven) such as glass, quartz, polyester, polyimide, polypropylene, cellulose, carbon fibers and carbon fibrils, nylon or acrylic fibers, preferably a glass substrate, that can be impregnated with the curable composition (i.e., prepregs).

In some embodiments, the curable composition further comprises a poly(phenylene ether) copolymer. The poly(phenylene ether) copolymer is ideally suited as a reactive component in the curable composition because it is bifunctional, with two reactive phenolic groups. In some embodiments, the curable epoxy composition can further comprise 1 to 100 parts by weight of the poly(phenylene ether) copolymer.

The curable epoxy composition does not include a catalyst. As used herein, “catalyst” means a catalyst compound that initiates polymerization of epoxide groups or accelerates the reaction of curing agents with epoxide groups, and can encompass various terms such as curing accelerators, hardening accelerators, curing catalysts, and curing promoters. Catalyst compounds include, but are not limited to, benzotriazoles; triazines; piperazines such as aminoethylpiperazine, N-(3-aminopropyl)piperazine, or the like; imidazoles such as 1-methylimidazole, 2-methylimidazole, 3-methyl imidazole, 4-methylimidazole, 5-methylimidazole, 1-ethylimidazole, 2-ethylimidazole, 3-ethylimidazole, 4-ethylimidazole, 5-ethylimidazole, 1-n-propylimidazole, 2-n-propylimidazole, 1-isopropylimidazole, 2-isopropylimidazole, 1-n-butylimidazole, 2-n-butylimidazole, 1-isobutylimidazole, 2-isobutylimidazole, 2-undecyl-1H-imidazole, 2-heptadecyl-1H-imidazole, 1,2-dimethylimidazole, 1,3-dimethylimidazole, 2,4-dimethylimidazole, 2-ethyl-4-methylimidazole, 1-phenylimidazole, 2-phenyl-1H-imidazole, 4-methyl-2-phenyl-1H-imidazole, 2-phenyl-4-methylimidazole, 1-benzyl-2-methylimidazole, 1-benzyl-2-phenylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 2-phenyl-4,5-dihydroxymethylimidazole, 2-phenyl-4-methyl-5-hydroxymethylimidazole, 1-cyanoethyl-2-phenyl-4,5-di(2-cyanoethoxy)methylimidazole; cyclic amidine such as 4-diazabicyclo(2,2,2)octane (DABCO), diazabicycloundecene (DBU), 2-phenyl imidazoline, or the like; N,N-dimethylaminopyridine (DMAP); sulfamidates; C₄₋₁₀ alkylamines such as di-n-butylamine, tri-n-butylamine, and 2-ethylhexylamine; tetra(C₁₋₈ alkyl)guanidines such as tetramethylguanidine; tertiary amines and salts thereof; ureas; metal salts of diketones such as aluminum tris(acetylacetonate) and zinc bis(acetylacetonate); diaryliodonium salts such as the tetrafluoroborate, hexafluorophosphate, hexafluoroarsenate and hexafluoroantimonate; ultraviolet-activated triarylsulfonium salts containing the same anions; arylene polyamides; phosphines, diphosphines, phosphine oxides, and phosphonium salts; sulfonic acids, sulfonamides, sulfones, and triarylsulfonium salts; metal salts of fatty acids; and phenolic compounds such as bisphenol A, pyrogallol, dihydroxydiphenyls, hydroxybenzaldehydes such as salicylaldehyde, catechol, resorcinol, hydroquinone, phenol-formaldehyde or resorcinol-formaldehyde condensates and halogenated phenols.

The curable epoxy composition can be manufactured by combining the epoxy resin composition and the aromatic dianhydride curing agent at a temperature of 130 to 200° C., preferably 140 to 190° C., more preferably 150 to 180° C. to provide a reaction mixture. The curable epoxy composition is then formed from the reaction mixture.

In some embodiments, the reaction mixture contains no solvent or reactive diluent solvent. In other embodiments, the curable epoxy composition and/or the reaction mixture further includes a solvent, for example C₃₋₈ ketones, C₄-C₈ N,N-dialkylamides, C₄₋₁₆ dialkyl ethers, C₆₋₁₂ aromatic hydrocarbons, C₃₋₆ alkyl alkanoates, C₂₋₆ alkyl nitriles, C₂₋₆ dialkyl sulfoxides, or a combination comprising at least one of the foregoing. Examples of C₃₋₈ ketones include acetone, methyl ethyl ketone, methyl isobutyl ketone, and combinations comprising at least one of the foregoing. Examples of C₄₋₈ N,N-dialkylamides include dimethylformamide, dimethylacetamide, N-methyl-2-pyrrolidone, and combinations comprising at least one of the foregoing. Examples of C₄₋₁₆ dialkyl ethers include tetrahydrofuran, dioxane, and combinations comprising at least one of the foregoing. The C₄₋₁₆ dialkyl ether can optionally further include one or more ether oxygen atoms within the alkyl groups and one or more hydroxy substituents on the alkyl groups, for example the C₄₋₁₆ dialkyl ether can be ethylene glycol monomethyl ether. The aromatic hydrocarbon solvent can be an ethylenically unsaturated solvent. Examples of C₆₋₁₂ aromatic hydrocarbons include benzene, toluene, xylenes, styrene, divinylbenzenes, and combinations comprising at least one of the foregoing. Examples of C₃₋₆ alkyl alkanoates include methyl acetate, ethyl acetate, methyl propionate, ethyl propionate, and combinations comprising at least one of the foregoing. Examples of C₂₋₆ alkyl cyanides include acetonitrile, propionitrile, butyronitrile, and combinations comprising at least one of the foregoing. Examples of C₂-C₆ dialkyl sulfoxides include dimethyl sulfoxide, methyl ethyl sulfoxide, diethyl sulfoxide, and combinations comprising at least one of the foregoing. In some embodiments, the solvent comprises acetone, methyl ethyl ketone, N-methyl-2-pyrrolidone, toluene, or a combination comprising at least one of the foregoing. In still other embodiments, the solvent can be a halogenated solvent such as methylene chloride, chloroform, 1,1,1-trichloroethane, chlorobenzene, or the like.

In another aspect, disclosed is a thermoset epoxy composition that includes a cured product of the curable epoxy composition. The cured product of the curable epoxy composition can be obtained as provided herein.

The thermoset epoxy composition including the cured composition can exhibit a single glass transition temperature (T_{g}), such as a single T_{g} greater than or equal to 170° C., preferably greater than or equal to 180° C., more preferably greater than or equal to 200° C. The glass transition temperature can be determined using dynamic mechanical analysis (DMA). Alternatively, T_{g} can be determined using differential scanning calorimetry (DSC) with a heating rate of 10° C./minute or 20° C./minute.

The resulting thermoset epoxy composition after curing can be clear and/or transparent. The thermoset epoxy composition including the cured composition can exhibit a light transmission of greater than 50%, preferably greater than 70%, more preferably greater than 90%. The light transmission can be determined on a 2 millimeter (mm) plaque according to ASTM D1003. As used herein, “light transmission” means transmission of visible light in a wavelength region of 380 to 750 nanometers (nm).

In a preferred embodiment, the thermoset epoxy composition has a glass transition temperature of greater than or equal to 170° C., preferably greater than or equal to 180° C., more preferably greater than or equal to 200° C., as determined by dynamic mechanical analysis; and a light transmission of greater than 50%, preferably greater than 70%, more preferably greater than 90%, as determined according to ASTM D1003 on a 2 mm plaque.

The thermoset epoxy composition can be manufactured by curing the curable epoxy composition. There is no particular limitation on the method by which the composition may be cured. The composition may be cured, for example, by thermal curing or radiation curing. Combinations of thermal curing and radiation curing can also be used. When thermal curing is used, the heating temperature can be from 80 to 300° C., preferably 120 to 240° C. The heating period can be from 1 minute to 10 hours, preferably 1 minute to 6 hours, more preferably 3 hours to 5 hours. The curing process can be staged to produce a partially cured and often tack-free resin, which then is fully cured by heating for longer periods or temperatures within the aforementioned ranges. Radiation curing can be performed using ultraviolet light or electron beams.

In particular embodiments, the curable epoxy composition can be cured by compression molding, injection molding, transfer molding, pultrusion, resin casting, or a combination comprising at least one of the foregoing. In some embodiments, the curable epoxy composition can be disposed in, for example injected into, a mold and then cured at 150 to 260° C. in the mold. The curing time can be from 1 to 15 hours in the mold. Various molded articles or components can be prepared in this manner, including those described herein.

The thermoset epoxy composition can exhibit good ductility, good fracture toughness, unnotched Izod impact strength, and good tensile elongation.

The thermoset epoxy composition can exhibit increased char formation on pyrolysis.

The thermoset epoxy composition can exhibit low moisture absorption.

The thermoset epoxy composition can exhibit decreased shrinkage upon curing.

The thermoset epoxy composition can exhibit decreased dielectric properties.

The disclosed curable epoxy compositions and thermoset epoxy compositions can be used in a variety of applications and articles, including any applications where conventional epoxides are currently used. Exemplary uses and applications include coatings such as protective coatings, sealants, weather resistant coatings, scratch resistant coatings, and electrical insulative coatings; adhesives; binders; glues; composite materials such as those using carbon fiber and fiberglass reinforcements. When utilized as a coating, the disclosed compounds and compositions can be deposited on a surface of a variety of underlying substrates. For example, the compositions can be deposited on a surface of metals, plastics, glass, fiber sizings, ceramics, stone, wood, or any combination thereof. The disclosed compositions can be used as a coating on a surface of a metal container, such as those commonly used for packaging and containment in the paint and surface covering industries. In some instances the coated metal is aluminum or steel.

Articles that can be prepared using the disclosed curable epoxy compositions and thermoset epoxy compositions include, for example, electrical components, and computer components. Other articles include, for example, components of transport, including bicycle, motorcycle, automotive, aircraft, and watercraft exterior and interior components. In some embodiments, the article is in the form of in the form of a composite, a foam, a fiber, a layer, a coating, an encapsulant, an adhesive, a sealant, a component, a prepreg, a casing, or a combination comprising at least one of the foregoing. In certain embodiments, the disclosed curable epoxy compositions are used for the production of composite materials for use in the aerospace industry. The curable epoxy compositions can be used in forming composites used for printed circuit boards. Methods of forming composites for use in printed circuit boards are known in the art and are described in, for example, U.S. Pat. No. 5,622,588 to Weber, U.S. Pat. No. 5,582,872 to Prinz, and U.S. Pat. No. 7,655,278 to Braidwood.

Additional applications include, for example, acid bath containers; neutralization tanks; aircraft components; bridge beams; bridge deckings; electrolytic cells; exhaust stacks; scrubbers; sporting equipment; stair cases; walkways; automobile exterior panels such as hoods and trunk lids; floor pans; air scoops; pipes and ducts, including heater ducts; industrial fans, fan housings, and blowers; industrial mixers; boat hulls and decks; marine terminal fenders; tiles and coatings; building panels; business machine housings; trays, including cable trays; concrete modifiers; dishwasher and refrigerator parts; electrical encapsulants; electrical panels; tanks, including electrorefining tanks, water softener tanks, fuel tanks, and various filament-wound tanks and tank linings; furniture; garage doors; gratings; protective body gear; luggage; outdoor motor vehicles; pressure tanks; printed circuit boards; optical waveguides; radomes; railings; railroad parts such as tank cars; hopper car covers; car doors; truck bed liners; satellite dishes; signs; solar energy panels; telephone switchgear housings; tractor parts; transformer covers; truck parts such as fenders, hoods, bodies, cabs, and beds; insulation for rotating machines including ground insulation, turn insulation, and phase separation insulation; commutators; core insulation and cords and lacing tape; drive shaft couplings; propeller blades; missile components; rocket motor cases; wing sections; sucker rods; fuselage sections; wing skins and fairings; engine narcelles; cargo doors; tennis racquets; golf club shafts; fishing rods; skis and ski poles; bicycle parts; transverse leaf springs; pumps, such as automotive smog pumps; electrical components, embedding, and tooling, such as electrical cable joints; wire windings and densely packed multi-element assemblies; sealing of electromechanical devices; battery cases; resistors; fuses and thermal cut-off devices; coatings for printed wiring boards; casting items such as capacitors, transformers, crankcase heaters; small molded electronic parts including coils, capacitors, resistors, and semiconductors; as a replacement for steel in chemical processing, pulp and paper, power generation, and wastewater treatment; scrubbing towers; pultruded parts for structural applications, including structural members, gratings, and safety rails; swimming pools, swimming pool slides, hot-tubs, and saunas; drive shafts for under the hood applications; dry toner resins for copying machines; marine tooling and composites; heat shields; submarine hulls; prototype generation; development of experimental models; laminated trim; drilling fixtures; bonding jigs; inspection fixtures; industrial metal forming dies; aircraft stretch block and hammer forms; vacuum molding tools; flooring, including flooring for production and assembly areas, clean rooms, machine shops, control rooms, laboratories, parking garages, freezers, coolers, and outdoor loading docks; electrically conductive compositions for antistatic applications; for decorative flooring; expansion joints for bridges; injectable mortars for patch and repair of cracks in structural concrete; grouting for tile; machinery rails; metal dowels; bolts and posts; repair of oil and fuel storage tanks, and numerous other applications.

Methods of forming a composite can include impregnating a reinforcing structure with a curable epoxy composition; partially curing the curable epoxy composition to form a prepreg; and laminating one or a plurality of prepregs. The lamination can include disposing an additional layer, e.g., an electrically conductive layer or an adhesive or bond ply on a side of a prepreg before lamination. The lamination can include disposing an additional layer, e.g., an electrically conductive layer or an adhesive or bond ply on a side of a prepreg before lamination.

Reinforcing structures suitable for prepreg formation are known in the art. Suitable reinforcing structures include reinforcing fabrics. Reinforcing fabrics include those having complex architectures, including two or three-dimensional braided, knitted, woven, and filament wound. The curable epoxy composition is capable of permeating such complex reinforcing structures. The reinforcing structure can comprise fibers of materials known for the reinforcement of plastics material, for example fibers of carbon, glass, metal, and aromatic polyamides. Suitable reinforcing structures are described, for example, in Anonymous (Hexcel Corporation), “Prepreg Technology”, March 2005, Publication No. FGU 017b; Anonymous (Hexcel Corporation), “Advanced Fibre Reinforced Matrix Products for Direct Processes”, June 2005, Publication No. ITA 272; and Bob Griffiths, “Farnborough Airshow Report 2006”, CompositesWorld.com, September 2006. The weight and thickness of the reinforcing structure are chosen according to the intended use of the composite using criteria well known to those skilled in the production of fiber reinforced resin composites. The reinforced structure can contain various finishes suitable for the epoxy matrix.

The method of forming the composite can comprise partially curing the curable epoxy composition after the reinforcing structure has been impregnated with it. Partial curing is curing sufficient to reduce or eliminate the wetness and tackiness of the curable composition but not so great as to fully cure the composition. The resin in a prepreg is customarily in the partially cured state, and those skilled in the thermoset arts, and particularly the reinforced composite arts, understand the concept of partial curing and how to determine conditions to partially cure a resin without undue experimentation. References herein to properties of the “cured epoxy composition” refer to a composition that is substantially fully cured. For example, the resin in a laminate formed from prepregs is typically substantially fully cured. One skilled in the thermoset arts can determine whether a sample is partially cured or substantially fully cured without undue experimentation. For example, one can analyze a sample by differential scanning calorimetry (DSC) to look for an exotherm indicative of additional curing occurring during the analysis. A sample that is partially cured will exhibit an exotherm. A sample that is substantially fully cured will exhibit little or no exotherm. Partial curing can be effected by subjecting the curable-composition-impregnated reinforcing structure to a temperature of 133 to 140° C. for 4 to 10 minutes.

Commercial-scale methods of forming composites are known in the art, and the curable epoxy compositions described herein are readily adaptable to existing processes and equipment. For example, prepregs are often produced on treaters. The main components of a treater include feeder rollers, a resin impregnation tank, a treater oven, and receiver rollers. The reinforcing structure (E-glass, for example) is usually rolled into a large spool. The spool is then put on the feeder rollers that turn and slowly roll out the reinforcing structure. The reinforcing structure then moves through the resin impregnation tank, which contains the curable composition. The varnish impregnates the reinforcing structure. After emerging from the tank, the coated reinforcing structure moves upward through the vertical treater oven, which is typically at a temperature of 175 to 200° C., and the solvent of the varnish is boiled away. The resin begins to polymerize at this time. When the composite comes out of the tower it is sufficiently cured so that the web is not wet or tacky. The cure process, however, is stopped short of completion so that additional curing can occur when laminate is made. The web then rolls the prepreg onto a receiver roll.

While the above-described curing methods rely on thermal curing, it is also possible to effect curing with radiation, including ultraviolet light and electron beams. Combinations of thermal curing and radiation curing can also be used.

Processes useful for preparing the articles and materials include those generally known to the art for the processing of thermosetting resins. Such processes have been described in the literature as in, for example, Engineered Materials Handbook, Volume 1, Composites, ASM International Metals Park, Ohio, copyright 1987 Cyril A. Dostal Senior Ed, pp. 105-168 and 497-533, and “Polyesters and Their Applications” by Bjorksten Research Laboratories, Johan Bjorksten (pres.) Henry Tovey (Ch. Lit. Ass.), Betty Harker (Ad. Ass.), James Henning (Ad. Ass.), Reinhold Publishing Corporation, N.Y., 1956. Processing techniques include resin transfer molding; sheet molding; bulk molding; pultrusion; injection molding, including reaction injection molding (RIM); atmospheric pressure molding (APM); casting, including centrifugal and static casting open mold casting; lamination including wet or dry lay-up and spray lay up; also included are contact molding, including cylindrical contact molding; compression molding; including vacuum assisted resin transfer molding and chemically assisted resin transfer molding; matched tool molding; autoclave curing; thermal curing in air; vacuum bagging; pultrusion; Seeman's Composite Resin Infusion Manufacturing Processing (SCRIMP); open molding, continuous combination of resin and glass; and filament winding, including cylindrical filament winding. In certain embodiments, an article can be prepared from the disclosed curable compositions via a resin transfer molding process.

This disclosure is further illustrated by the following examples, which are non-limiting.

### EXAMPLES

Materials used in the examples are described in Table 1.

TABLE 1

| Component | Description | Source |
|---|---|---|
| BPA-DGE | Diglycidyl ether of bisphenol A, CAS | Sigma-Aldrich |
| | Reg. No. 1675-54-3. | |
| BPA-DA | Bisphenol A dianhydride, CAS Reg. No. | SABIC |
| | 38103-06-9. | |
| MTHPA | Tetrahydro-4-methylphthalic anhydride, | TCI Chemicals |
| | CAS Reg. No. 34090-76-1. | |
| MHHPA | Hexahydro-4-methylphthalic anhydride, | Sigma-Aldrich |
| | CAS Reg. No. 19438-60-9. | |
| NMA | Methyl-5-norbornene-2,3-dicarboxylic | Sigma-Aldrich |
| | anhydride, CAS Reg. No. 25134-21-8. | |
| PMDA | Pyromellitic dianhydride, CAS Reg. No. | Sigma-Aldrich |
| | 89-32-7. | |

### Sample Preparation

### Example 1

BPA-DGE is heated at 160° C. and combined with BPA-DA at an anhydride to epoxy (A/E) ratio of 0.8:1 by weight. A homogenous and transparent reaction mixture is afforded. The reaction mixture was poured into a preheated mold (130° C.) and then cured in the mold at 220° C. for 1 hour to provide a rigid and clear casting.

### Example 2

The same procedure as Example 1 was followed, except the curing time was 3 hours.

### Example 3

The same procedure as Example 1 was followed, except the curing time was 5 hours.

### Example 4

The same procedure as Example 1 was followed, except the curing time was 7 hours.

### Example 5

The same procedure as Example 1 was followed, except the curing time was 15 hours.

### Comparative Example 1

BPA-DGE was combined with MHHPA at 23° C. with an A/E ratio of 0.8:1 by weight. The reaction mixture was heated at 90° C. and then poured into a preheated mold (130° C.) and cured in the mold at 220° C. for 1 hour. No rigid epoxy resin was afforded.

### Comparative Example 2

The same procedure as Comparative Example 1 was used, except the curing time as 15 hours. No rigid epoxy resin was afforded.

### Comparative Example 3

The same procedure as Comparative Example 1 was used, except the curing agent was MTHPA. No rigid epoxy resin was afforded.

### Comparative Example 4

The same procedure as Comparative Example 3 was used, except the curing time as 15 hours. No rigid epoxy resin was afforded.

### Comparative Example 5

The same procedure as Comparative Example 1 was used, except the curing agent was NMA. No rigid epoxy resin was afforded.

### Comparative Example 6

The same procedure as Comparative Example 5 was used, except the curing time was 15 hours. No rigid epoxy resin was afforded.

### Comparative Example 7

BPA-DGE is heated at 160° C. and combined with PMDA at an A/E ratio of 0.8:1 by weight. The resulting mixture had light yellow color and a substantial amount of the PMDA remained undissolved with stirring. The reaction mixture was poured into a mold preheated at 130° C., and then cured in the mold at 220° C. for 1 hour to provide a rigid and cured resin having undissolved particles of PMDA distributed therein.

### Comparative Example 8

The same procedure as Comparative Example 7 was used, except the curing time was 15 hours. The resulting product was a rigid and cured resin having undissolved particles of PMDA distributed therein

### Sample Analysis

The glass transition temperature (T_{g}) was determined by dynamic mechanical analysis (DMA) using an RDA III DMA from Rheometric Scientific. Sample bars were prepared (40 mm length, 4 mm width, and 6 mm thickness) and analyzed at −40 to 300° C. with a temperature ramp of 3° C. per minute and at a frequency of 6.283 radians per second.

### Evaluation

Table 2 shows the curing agent, catalyst, curing time (hours, hr), rigidity, and clarity for Examples 1 to 5 and Comparative Examples 1 to 8. Rigidity and clarity are the qualitative properties of the cured sample.

TABLE 2

| | | | Curing | | |
|---|---|---|---|---|---|
| | Curing Agent | Catalyst | Time (hr) | Rigidity | Clarity |
| Example 1 | BPA-DA | No | 1 | Yes | Yes |
| Example 2 | BPA-DA | No | 3 | Yes | Yes |
| Example 3 | BPA-DA | No | 5 | Yes | Yes |
| Example 4 | BPA-DA | No | 7 | Yes | Yes |
| Example 5 | BPA-DA | No | 15 | Yes | Yes |
| Comparative | MHHPA | No | 1 | No | No |
| Example 1 | | | | | |
| Comparative | MHHPA | No | 15 | No | No |
| Example 2 | | | | | |
| Comparative | MTHPA | No | 1 | No | No |
| Example 3 | | | | | |
| Comparative | MTHPA | No | 15 | No | No |
| Example 4 | | | | | |
| Comparative | NMA | No | 1 | No | No |
| Example 5 | | | | | |
| Comparative | NMA | No | 15 | No | No |
| Example 6 | | | | | |
| Comparative | PMDA | No | 1 | Yes | No |
| Example 7 | | | | | |
| Comparative | PMDA | No | 15 | Yes | No |
| Example 8 | | | | | |

As shown in Table 2, BPA-DGE can be cured to provide clear and rigid castings using BPA-DA as the curing agent without the necessity of an added catalyst. Curing times of 1 to 15 hours were effective in Examples 1 to 5.

In contrast, anhydride curing agents such as MHHPA, MTHPA, and NMA in Comparative Examples 1-6 were ineffective in curing BPA-DGE and failed to provide clear and rigid resins under same curing conditions. In Comparative Examples 7 and 8, the dianhydride curing agent PMDA provided a rigid, cured resin without sufficient clarity and having a significant amount of undissolved PMDA particles embedded into the cured resin.

Table 3 shows the curing time (hr) and T_{g} (° C.) for Examples 1 to 5.

TABLE 3

| | Curing Time (hr) | T_{g} (° C.) |
|---|---|---|
| Example 1 | 1 | 213 |
| Example 2 | 3 | 218 |
| Example 3 | 5 | 232 |
| Example 4 | 7 | 240 |
| Example 5 | 15 | 243 |

As shown in Table 3, Examples 1 to 5 had glass transition temperatures of greater than 210° C. The glass transition temperature was found to increase as a function of curing time.

The results show that the aromatic dianhydride curing agent BPA-DA can be used to provide high temperature, rigid, and clear epoxy resins in the absence of any added catalyst. Cured epoxide resins having similar properties were not obtained in the absence of an added catalyst for the anhydride curing agents MHHPA, MTHPA, NMA, and PMDA.

This disclosure further encompasses the following aspects.

Aspect 1: A curable epoxy composition, comprising: 100 parts by weight of an epoxy resin composition comprising one or more epoxy resins, each independently having an epoxy equivalent weight of at least 2; 30 to 200 parts by weight of an aromatic dianhydride curing agent of formula (1)

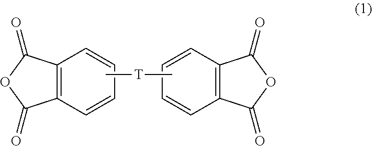

wherein T is —O—, —S—, —C(O)—, —SO₂—, —SO—, —C_{y}H_{2y}— wherein y is an integer from 1 to 5 or a halogenated derivative thereof, or —O—Z—O— wherein Z is an aromatic C₆₋₂₄ monocyclic or polycyclic moiety optionally substituted with 1 to 6 C₁₋ₛ alkyl groups, 1 to 8 halogen atoms, or a combination comprising at least one of the foregoing, wherein the composition does not contain a catalyst.

Aspect 2: The curable epoxy composition according to Aspect 1, wherein a stoichiometric ratio between the aromatic dianhydride curing agent and the epoxy resin composition is 0.1:1 to 2.0:1, preferably 0.4:1 to 1.2:1, more preferably 0.6:1 to 1:1.

Aspect 3: The curable epoxy composition according to Aspect 1 or Aspect 2, wherein the epoxy resin composition comprises a bisphenol A epoxy resin, a triglycidyl-substituted epoxy resin, a tetraglycidyl-substituted epoxy resin, a bisphenol F epoxy resin, a phenol novolak epoxy resin, a cresol novolak epoxy resin, a cycloaliphatic diglycidyl ester epoxy resin, a cycloaliphatic epoxy resin comprising a ring epoxy group, an epoxy resin containing a spiro-ring, a hydantoin epoxy resin, or a combination comprising at least one of the foregoing.

Aspect 4: The curable epoxy composition according to any one or more of the preceding Aspects, wherein T is —O— or a group of the formula —O—Z—O— wherein Z is of formula (2)

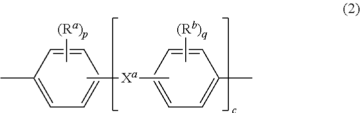

wherein R^{a} and R^{b} are each independently the same or different, and are a halogen atom or a monovalent C₁₋₆ alkyl group, X^{a} is a single bond, —O—, —S—, —S(O)—, —S(O)₂—, —C(O)—, or a C₁₋₁₈ organic bridging group, and p, q, and c are each independently integers of 0 to 4.

Aspect 5: The curable epoxy composition according to Aspect 4, wherein Z is a divalent group of formula (3a) or (3b)

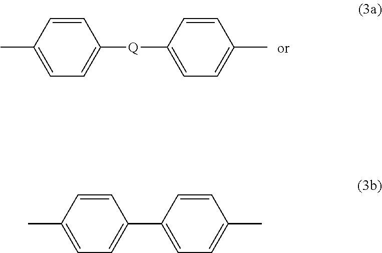

wherein Q is —O—, —S—, —C(O)—, —SO₂—, —SO—, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof, preferably wherein Q is 2,2-isopropylidene.

Aspect 6: The curable epoxy composition according to any one or more of the preceding Aspects, further comprising an additive composition; preferably wherein the additive composition comprises a particulate filler, a fibrous filler, an antioxidant, a heat stabilizer, a light stabilizer, a ultraviolet light stabilizer, a ultraviolet light-absorbing compound, a near infrared light-absorbing compound, an infrared light-absorbing compound, a plasticizer, a lubricant, a release agent, a antistatic agent, an anti-fog agent, an antimicrobial agent, a colorant, a surface effect additive, a radiation stabilizer, a flame retardant, an anti-drip agent, a fragrance, an adhesion promoter, a flow enhancer, a coating additive, a polymer different from the thermoset polymer, or a combination comprising at least one of the foregoing; more preferably wherein the additive composition comprises a flame retardant, a particulate filler, a fibrous filler, an adhesion promoter, a flow enhancer, a coating additive, a colorant, or a combination comprising at least one of the foregoing.

Aspect 7: A method for the manufacture of the curable epoxy composition according to any one or more of the preceding Aspects, the method comprising contacting the epoxy resin composition and the aromatic dianhydride curing agent at a temperature of 130 to 200° C., preferably 140 to 190° C., more preferably 150 to 180° C. to provide the curable epoxy composition.

Aspect 8: The method of Aspect 7, wherein the reaction mixture contains no solvent or reactive diluent solvent.

Aspect 9: A thermoset epoxy composition comprising a cured product of the curable epoxy composition according to any one or more of Aspects 1 to 6.

Aspect 10: The thermoset epoxy composition according to according to Aspect 9, which after curing has at least one of: a glass transition temperature of greater than or equal to 170° C., preferably greater than or equal to 180° C., more preferably greater than or equal to 200° C., as determined by dynamic mechanical analysis; and a light transmission of greater than 50%, preferably greater than 70%, more preferably greater than 90%, as determined according to ASTM D1003 on a 2 mm plaque.

Aspect 11: A method for the manufacture of a thermoset epoxy composition, the method comprising: curing the curable epoxy composition of any one or more of Aspects 1 to 6, wherein the curing is performed without a catalyst; preferably wherein the curing of the curable epoxy composition comprises compression molding, injection molding, transfer molding, pultrusion, resin casting, or a combination comprising at least one of the foregoing.

Aspect 12: The method of Aspect 13, wherein the curing comprises disposing the curable epoxy composition into a mold, and curing the epoxy resin composition at 150 to 260° C. for 1 to 15 hours in the mold.

Aspect 13: An article comprising the thermoset epoxy composition of Aspect 9 or Aspect 10.

Aspect 14: The article of Aspect 13, wherein the article is in the form of in the form of a composite, a foam, a fiber, a layer, a coating, an encapsulant, an adhesive, a sealant, a component, a prepreg, a casing, or a combination comprising at least one of the foregoing.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt %, or, more specifically, 5 to 25 wt %”, is inclusive of the endpoints and all intermediate values of the ranges of “5 wt % to 25 wt %,” etc.). Disclosure of a narrower range or more specific group in addition to a broader range is not a disclaimer of the broader range or larger group. The singular forms “a” “an,” and “the” include plural referents unless the context clearly dictates otherwise.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

The term “hydrocarbyl” refers to a monovalent group containing carbon and hydrogen. Hydrocarbyl can be alkyl, cycloalkyl, alkenyl, cycloalkenyl, aryl, alkylaryl, or arylalkyl as defined below. The term “hydrocarbylene” refers to a divalent group containing carbon and hydrogen. Hydrocarbylene can be alkylene, cycloalkylene, arylene, alkylarylene, or arylalkylene as defined below. The term “alkyl” means a branched or straight chain, unsaturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ—, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentenyl and cyclohexenyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group. “Amino” means a radical of the formula —NRR′ wherein R and R′ are independently hydrogen or a C₁-C₃₀ hydrocarbyl, for example a C₁-C₂₀ alkyl group or a C₆-C₃₀ aryl group. “Halogen” or “halogen atom” means a fluorine, chlorine, bromine, or iodine atom. The prefix “halo” means a group or compound including one more of a fluoro, chloro, bromo, or iodo substituent. A combination of different halo groups (e.g., bromo and fluoro), or only chloro groups can be present. The prefix “hetero” means that the compound or group includes at least one ring member that is a heteroatom (e.g., 1, 2, or 3 heteroatom(s)), wherein the heteroatom(s) is each independently N, O, S, Si, or P. The suffix “oxy” indicates that the open valence of the group is on an oxygen atom and the suffix “thio” indicates that the open valence of the group is on a sulfur atom.

Unless substituents are otherwise specifically indicated, each of the foregoing groups can be unsubstituted or substituted, provided that the substitution does not significantly adversely affect synthesis, stability, or use of the compound. “Substituted” means that the compound, group, or atom is substituted with at least one (e.g., 1, 2, 3, or 4) substituents instead of hydrogen, where each substituent is independently nitro (—NO₂), cyano (—CN), hydroxy (—OH), halogen, thiol (—SH), thiocyano (—SCN), C₁₋₆ alkyl, C₂₋₆ alkenyl, C₂₋₆ alkynyl, C₁₋₆ haloalkyl, C₁₋₉ alkoxy, C₁₋₆ haloalkoxy, C₃₋₁₂ cycloalkyl, C₅₋₁₈ cycloalkenyl, C₆₋₁₂ aryl, C₇₋₁₃ arylalkylene (e.g., benzyl), C₇₋₁₂ alkylarylene (e.g., toluyl), C₄₋₁₂ heterocycloalkyl, C₃₋₁₂ heteroaryl, C₁₋₆ alkyl sulfonyl (—S(═O)₂-alkyl), C₆₋₁₂ arylsulfonyl (—S(═O)₂-aryl), or tosyl (CH₃C₆H₄SO₂—), provided that the normal valence of the substituted atom is not exceeded. When a compound or group is substituted, the indicated number of carbon atoms is the number of carbon atoms in the compound or group, excluding those of any substituents.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A curable epoxy composition, comprising:
100 parts by weight of an epoxy resin composition comprises an epoxy resin that is a bisphenol A epoxy resin, a triglycidyl-substituted epoxy resin, a tetraglycidyl-substituted epoxy resin, a bisphenol F epoxy resin, a phenol novolak epoxy resin, a cresol novolak epoxy resin, a cycloaliphatic diglycidyl ester epoxy resin, a cycloaliphatic epoxy resin comprising a ring epoxy group, a hydantoin epoxy resin, or a combination thereof;
30 to 200 parts by weight of an aromatic dianhydride curing agent of formula (1) 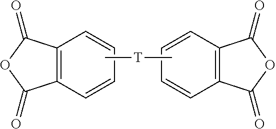
wherein T is —O—, —S—, —SO₂—, or —O—Z—O— wherein Z is an aromatic C₆₋₂₄ monocyclic or polycyclic moiety optionally substituted with 1 to 6 C₁₋₁₈ alkyl groups, 1 to 8 halogen atoms, or a combination thereof,
wherein the composition does not contain a catalyst.

2. The curable epoxy composition according to claim 1, wherein a stoichiometric ratio between the aromatic dianhydride curing agent and the epoxy resin composition is 0.1:1 to 2.0:1.

3. The curable epoxy composition according to claim 1, wherein the epoxy resin composition comprises a bisphenol A epoxy resin.

4. The curable epoxy composition according to claim 1, wherein T is —O— or a group of the formula —O—Z—O— wherein Z is of formula (2) 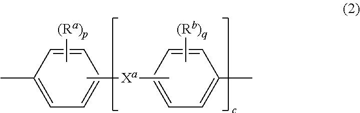
wherein
R^{a} and R^{b} are each independently the same or different, and are a halogen atom or a monovalent C₁₋₆ alkyl group,
X^{a} is a single bond, —O—, —S—, —S(O)—, —S(O)₂—, —C(O)—, or a C₁₋₁₈ organic bridging group, and
p, q, and c are each independently integers of 0 to 4.

5. The curable epoxy composition according to claim 4, wherein Z is a divalent group of formula (3a) or (3b) 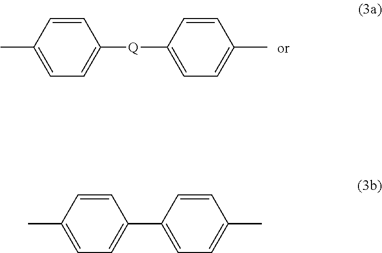
wherein Q is —O—, —S—, —C(O)—, —SO₂—, —SO—, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof.

6. The curable epoxy composition according to claim 1, further comprising an additive composition.

7. (canceled)

8. (canceled)

9. (canceled)

10. The curable epoxy composition according to claim 1, wherein a cured product of the curable epoxy composition has at least one of:
a glass transition temperature of greater than or equal to 170° C., as determined by dynamic mechanical analysis; and
a light transmission of greater than 50%, as determined according to ASTM D1003 on a 2 mm plaque.

11. A method for the manufacture of a thermoset epoxy composition, the method comprising:
contacting the epoxy resin composition and the aromatic dianhydride curing agent at a temperature of 130 to 200° C. to provide the curable epoxy composition of claim 1; and
curing the curable epoxy composition.

12. The method of claim 11, wherein the curing comprises disposing the curable epoxy composition into a mold, and curing the curable epoxy composition at 150 to 260° C. for 1 to 15 hours in the mold.

13. An article comprising a cured product of the curable epoxy composition according to claim 1.

14. The article of claim 13, wherein the article is in the form of a composite, a foam, a fiber, a layer, a coating, an encapsulant, an adhesive, a sealant, a component, a prepreg, a casing, or a combination thereof.

15. The method according to claim 11, wherein the curable epoxy composition contains no solvent or reactive diluent.

16. The method according to claim 11, wherein the epoxy resin composition and the aromatic dianhydride curing agent are contacted without a solvent or a reactive diluent.

17. The method according to claim 11, wherein the curing is performed without a catalyst.

18. The method according to claim 11, wherein a method for the curing of the curable epoxy composition is compression molding, injection molding, transfer molding, pultrusion, resin casting, or a combination thereof.

19. The method according to claim 11, wherein the temperature of the contacting of the epoxy resin composition and the aromatic dianhydride is 140 to 190° C.

20. The method according to claim 11, wherein a cured product of the curable epoxy composition has a glass transition temperature of greater than or equal to 180° C., as determined by dynamic mechanical analysis.

21. The curable epoxy composition according to claim 1, comprising 50 to 150 parts by weight of the aromatic dianhydride curing agent.

22. The curable epoxy composition according to claim 1, wherein the epoxy resin composition does not comprise an epoxy resin containing a spiro-ring.

23. The curable epoxy composition according to claim 1, wherein the curable epoxy composition does not comprise a benzotriazole, a triazine, a piperazine, an imidazole, a cyclic amidine, N,N-dimethylaminopyridine, a sulfamidate, a C₄₋₁₀ alkylamine, a tetra(C₁₋₁₈ alkyl)guanidine, a tertiary amine or salt thereof, a urea, a sulfonamide, or a sulfone.
